(19) United States
(12) Patent Application Publication
(10) Pub. No.: US 2004/0185243 A1
(43) Pub. Date: Sep. 23, 2004

(54) Pre-applied outer layer material for automotive interior trim and method for production of automotive interior trim

(76) Inventors: Hideyuki Kakinuma, Saitama (JP); Hiroaki Suzuki, Chiba (JP); Tetsuya Oda, Tochigi-ken (JP); Atsushi Kawata, Utsunomiya-shi (JP)

Correspondence Address: Mathews, Collins, Shepherd & McKay, P.A., Suite 306, 100 Thanet Circle, Princeton, NJ, 08540, US

(21) Appl. No.: 10/792,072

(22) Filed: Mar. 3, 2004

(30) Foreign Application Priority Data
Mar. 6, 2003 (JP) JP2003-060231

(51) Int. Cl. B32B 27/32

(52) U.S. Cl. 428/309.9; 428/523

(57) ABSTRACT

This invention, with the object of enabling the step of joining an outer layer material and a molded object for the production of an automotive interior trim to be copiously simplified, is aimed at providing a hotmelt excellent in resistance to heat and suitable for a pre-applied outer layer material for automotive interior trim such that the surface of the pre-applied layer thereof lacks viscosity and obviates the necessity for a release paper and possesses the ability to mold and adhere to a given molded object without being heated and a method for the production of an automotive interior trim by the use of the pre-applied outer layer material. This invention, therefore, is directed to providing a pre-applied outer layer material for automotive interior trim, which comprises having applied in advance to the back surface of an automotive interior trim a hotmelt having (A) an amorphous poly(α-olefin) having a melting viscosity in the range of 500-100,000 mPa·s/190° C., (B) a tackifier resin having a softening point determined by the ring and ball method of not lower than 110° C., and (C) a polypropylene wax having a melting point of not lower than 120° C. as essential components thereof and having a weight ratio (A) to (C) in the range of 100/50-100/100.

### BACKGROUND OF THE INVENTION

1. Field of the Invention

This invention relates to a pre-applied outer layer material for automotive interior trim and a method for the production of an automotive interior trim. More particularly, it relates, in an automotive interior trim produced via a step of thermally bonding an outer layer material and a molded article by using adhesives, to a pre-applied outer layer material having the adhesives applied in advance thereto and a method for the production of an automotive interior trim formed by using the pre-applied outer layer material.

2. Description of the Related Art

Nowadays, automobiles are furnished with numerous interior trim besides an installment panel, doors, a ceiling panel, a rear tray, and pillars. Such an interior trim is generally composed of an outer layer material and a molded object and these two components are generally bonded by thermally molding the outer layer material in conformity with the shape of the molded object by using solution type adhesives (official gazette of JP-A-2001-22655 and the official gazette of JP-A-2000-198940).

The outer layer material used herein is a sheetlike material which is either formed solely of a surface layer material made of a plastic sheet of polyvinyl chloride or thermoplastic polyolefin and a fibrous material such as tricot, woven fabric, or non-woven fabric or formed by laminating by adhesion or thermal fusion the surface layer material and a polyolefin foam produced by using polypropylene, polyethylene, polybutylene and a copolymer of such olefins as a main component. The outer layer material having a thickness in the approximate range of 0.3-1.5 mm and the polyolefin foam having a thickness in the approximate range of 1.5-3 mm are generally used. The term “molded object” as used herein means injection molded objects and sheets of various plastic materials such as acrylonitrile-butadiene-styrene resin (ABS resin) and polypropylene and ligneous molded objects and ligneous boards obtained by tightly heat-press molding wood chips and ligneous flour with a thermosetting resin or a polyolefin resin.

The adhesives heretofore used in automotive interior trim has been predominantly solvent type adhesives. It is directly applied to a given molded object. The molded object wet with the applied adhesives is dried and immediately transferred to the step of thermal vacuum forming. As typical examples of the adhesives which are used herein, chloroprene rubber type, nitrile rubber type, urethane type, acryl type, and polyester type adhesives maybe cited. Such adhesives are applied by spraying to a given molded object. This application, however, entails such problems as incurring heavy fly loss, readily producing uneven coating, and degrading the working atmosphere by the emission of an organic solvent. Since the interior trim have complicated shapes, however, no proper means of application is found except the technique of spraying. Thus, the molded objects must be subjected one after one to the coating work. Such is the true state of affairs. Meanwhile, a method which comprises applying adhesives in advance to a polyolefin foam and thermally bonding the polyolefin foam and a molded object in the subsequent step has been proposed. This method, however, is at a disadvantage in entailing the necessity of imparting tenacity to the adhesives for the purpose of enabling the adhesives to manifest fully satisfactory adhesiveness to the surface of the molded object and consequently necessitating insertion of a release paper or release film in the interface of the two components joined by adhesion for the purpose of preventing the applied layer of the adhesives from inducing the adverse phenomenon of blocking with the surface layer when the molded object now covered with the adhesives is being rolled up or cut prior to storage. Further, the release paper or release film is at a disadvantage in entailing an extra step of requiring itself to be separated individually at the step of adhesion and changing itself into a hardly reclaimable industrial waste.

The hotmelt, i.e. one type of the adhesives, is finding utility in various industries because it is at an advantage in enjoying the convenience of being applied in a fused state and completing adhesion on cooling, obviating the necessity for a solvent, and rendering itself adaptable to the environment. As the base polymer for the hotmelt, ethylene type copolymers such as ethylene-vinyl acetate copolymer, polyethylene, noncrystalline polypropylene, crystalline polypropylene, crystalline polybutylene, styrene type block copolymers, polyamides, and polyesters are chiefly adopted. The hotmelt is obtained by adding to such a base polymer a varying tackifier resin, oil, wax, and other varying additive. When an ethylene type copolymer, polyethylene, noncrystalline polypropylene, or a styrene type block copolymer is adopted as the base polymer, however, the hotmelt has the disadvantage of being deficient in resistance to heat notwithstanding it is enabled to manifest the adhesive property between low-polarity bases of polypropylene or between a low-polarity base and such a high-polarity substance as ligneous material or fabric (the official gazette of JP-A-HEI 12-226561).

As means to secure resistance to heat, (A) a method for imparting a high softening point and a high melting point to a base polymer and (B) a method for exalting the molecular weight of a base polymer thereby lowering the melt index thereof and lowering the high-temperature fluidity thereof may be conceivable.

In the case of the method of (A), the adhesives suffers a rise in the active temperature thereof, necessitates addition to the outer layer temperature of the base polymer during the course of vacuum forming, and fails to secure adhesiveness unless the molded object is preheated. In the case of the method of (B), the adhesives suffer a rise in the melting viscosity thereof and therefore render difficult the application thereof to the outer layer material. When a crystalline wax having a high melting point is used in the hotmelt, though the hotmelt reconciles resistance to heat and coating property, it is impracticable because the applied layer of the adhesives is brittle and readily breakable and, consequently, the components joined by adhesion exhibit no fully satisfactory adhesive strength and reveal conspicuous deficiency in resistance to shock.

When polyamide or polyester is used, the produced hotmelt is deficient in adhesiveness between low-polarity base polymers of polypropylene, for example, though it is capable of acquiring resistance to heat in itself.

A case of using crystalline polybutylene as the base polymer for the hotmelt has been known. The hotmelt, however, reveals deficiency in flexibility at low temperatures. It moreover encounters difficulty in satisfying the property of withstanding high temperatures in the neighborhood of 100° C. which is required in the application under consideration.

Meanwhile, as a means to repair the defects of the method using solvent type adhesives, the official gazette of JP-A-SHO 62-26499, for example, discloses a method for fabricating by composite molding a complex by having a hotmelt disposed in advance in a laminate formed of an outer layer material and a foam. This method, however, tends to entail such a problem as preventing conformation between the male die preparatorily fixing the surface of a molded object and the shape of the molded object.

Further, as one kind of hotmelt, a hotmelt comprising (A) 50-90 weight % of a noncrystalline olefin polymer, (B) 5-44 weight % of a crystalline ethylene polymer obtained by the polymerization of a monomer having a softening point of not lower than 120° C. and a crystalline polypropylene wax and/or ethylene content of not less than 65 weight %, and (C) 1-20 weight % of a tackifier resin is known (the official gazette of JP-A-HEI 12-226561).

The hotmelt of this composition, however, is at a disadvantage in revealing an unduly low 180-degree peel strength, an unduly large creep at 100° C., or both.

An object of this invention, therefore, is to provide a pre-applied outer layer material for an automotive interior trim obtained by using adhesives which precludes the phenomenon of blocking, lacks tenacity, and excels in durability and adhesive property and a method for the production of an automotive interior trim.

Another object of this invention is to provide a pre-applied outer layer material for automotive interior trim which enables the step of adhesion for the production of an automotive interior trim to be copiously curtailed and a method for the production of an automotive interior trim.

Yet another object of this invention is to provide a pre-applied outer layer material for automotive interior trim which possesses proper adhesiveness to an olefin material, exhibits an outstanding resistance to heat, and obviates the necessity for a solvent and a method for the production of an automotive interior trim.

### SUMMARY OF THE INVENTION

The objects mentioned above are accomplished by the following items (1)-(12).

(1) A pre-applied outer layer material for automotive interior trim, which comprises having applied in advance to the back surface of an automotive interior trim a hotmelt having (A) an amorphous poly(α-olefin) having a melting viscosity in the range of 500-100,000 mPa·s/190° C., (B) a tackifier resin having a softening point determined by the ring and ball method of not lower than 110° C., and (C) a polypropylene wax having a melting point of not lower than 120° C. as main components thereof and having a weight ratio of (A) to (C) in the range of 100/50-100/100.

(2) A pre-applied outer layer material set forth in (1) above, wherein the outer layer material for automotive interior trim is formed solely of a surface layer material and the hotmelt is directly applied in advance to the back surface of the outer layer material.

(3) A pre-applied outer layer material set forth in (1) above, wherein the outer layer material for automotive interior trim is formed of a surface layer material and a polyolefin foam layer joined to the back surface thereof by adhesion or thermal fusion and the hot melt is applied to the surface of the polyolefin foam layer.

(4) A pre-applied outer layer material set forth in (1) above, wherein the weight ratio of (A) the amorphous poly(α-olefin)/(B) the tackifier resin is in the range of 100/10-100/100.

(5) A pre-applied outer layer material set forth in (1) above, wherein the thickness of the hotmelt applied to the outer layer material is in the range of 10-500 μm.

(6) A pre-applied outer layer material set forth in (4) above, wherein the hotmelt further contains not more than 0 weight % of a polyolefin based on the weight of the hotmelt.

(7) A pre-applied outer layer material set forth in (3) above, wherein the outer layer material is formed solely of a thermoplastic sheet or fibrous material or formed by laminating a polyolefin foam thereon.

(8) A pre-applied outer layer material for automotive interior trim, which comprises having applied in advance to the back surface of an automotive interior trim a hotmelt having (A) an amorphous poly(α-olefin) having a melting viscosity in the range of 500-100,000 mPa·s/190° C., (B) a tackifier resin having a softening point determined by the ring and ball method of not lower than 110° C., and (C) a polypropylene wax having a melting point of not lower than 120° C. as main components, having a weight ratio of (A) to (C) in the range of 100/50-100/100, and having a weight ratio of (A) the amorphous poly (α-olefin)/(B) the tackifier resin in the range of 100/10-100/100.

(9) A pre-applied outer layer material set forth in (7) above, wherein the weight ratio of (A)/(C) is in the range of 100/30-100/60 and the weight ratio of (A)/(B) is in the range of 100/50-100/80.

(10) A pre-applied outer layer material set forth in (8) above, wherein the automotive interior trim is formed solely of a surface layer material and the hotmelt is directly applied in advance to the back surface of the surface layer material.

(11) A pre-applied outer layer material set forth in (8), wherein the automotive interior trim is formed of a surface layer material and a polyolefin foam layer joined by adhesion to the back surface thereof and the hotmelt is applied to the surface of the polyolefin foam layer.

(12) A method for the production of an automotive interior trim, comprising the steps of applying a pre-applied outer layer material set forth in (1) above to a molded object and subjecting them to vacuum forming adhesion without heating the molded object.

We, as a result of a diligent study, have found that adhesives resulting from compounding a specific amorphous poly (α-olefin) (hereinafter represented as “APAO”), a tackifier resin, and a high melting wax at a specific proportion is capable of adhering to a various substrate at an active temperature in the range of 100°-150° C. while retaining resistant to a temperature of 100° C.

We have further found that a pre-applied outer layer material capable of shunning the phenomenon of blocking and acquiring proper adhesiveness without heating the molded object can be provided by pre-applied a polyolefin foam with a hotmelt obtained by compounding APAO, a tackifier resin, and a polypropylene wax at a specific proportion.

The pre-applied upholstery (outer layer material) for automotive interior trim according to this invention which enables the step of adhesion for the production of an automotive interior trim to be copiously curtained as described above is very useful industrially because it possesses proper adhesiveness to an olefin material, exhibits outstanding resistance to heat, and obviates the necessity for a solvent.

### DESCRIPTION OF THE PREFERRED EMBODIMENT

The A component of the hotmelt to be used in this invention is an amorphous poly(α-olefin) having a melting viscosity in the range of 500-100,000 mPa·s/190° C., preferably 1,000-30,000 mPa·s/190° C. (hereinafter abbreviated as “APAO”). If the melting viscosity falls short of 500mPa·s/190° C., the shortage will result in preventing the produced hotmelt from acquiring fully satisfactory cohesive force. Conversely, if the melting viscosity exceeds 100,000 mPa·s/190° C., the excess will result in degrading the working property in applying the hotmelt by the use of a roll coater or a curtain spray, for example. As typical examples of the commercially available product of the A component, Ube Tack UT2115 (propylene homopolymer, melting viscosity 1,500 mPa·s/190° C.), UT2180 (propylene homopolymer, melting viscosity 8,000-8,500 mPa·s/190° C.), UT2215 (propylene-ethylene copolymer, melting viscosity 1,500 mPa·s/190° C.), UT2280 (propylene-ethylene copolymer, melting viscosity 8,000-8,500 mPa·s/190° C.), UT2330 (propylene-ethylene copolymer, melting viscosity 3,000-3,500 mPa·s/190° C.), UT2380 (propylene-ethylene copolymer, melting viscosity 8,000-8,500 mPa·s/190° C.), UT2585 (propylene-ethylene copolymer, melting viscosity 3,000-3,500 mPa·s/190° C.), UT2535 (propylene-ethylene copolymer, melting viscosity 8,000-8,500 mPa·s/190° C.), UT2730 (propylene-butene-1 copolymer, melting viscosity 3,000-3,500 mPa·s/190° C.), UT2715 (propylene-butene-1 copolymer, melting viscosity 1,500 mPa·s/190° C.), and UT2780 (propylene-butene-1 copolymer, melting viscosity 8,000-8,500 mPa·s/190° C.), E34200 (propylene-ethylene copolymer, melting viscosity 18,600 mPa·s/190° C.), E27200 (propylene-butene-1 copolymer, melting viscosity 19,200 mPa·s/190° C.) (which are all products of Ube Kosan K.K.), Vestoplast 750 (propylene-ethylene-butene-1 terpolymer, melting viscosity 50,000 mPa·s/190° C.) and Vestoplast 520 (propylene-ethylene-butene-1 terpolymer, melting viscosity 22,000 mPa·s/190° C.) (both products of Degussa AG), and Eastoflex Amorphous Polifein M1030 (propylene/propylene-ethylene copolymer mixture, melting viscosity 3,000 mPa·s/190° C.) and E-1060 (propylene-ethylene copolymer, melting viscosity 6,000 mPa·s/190° C.) (both products of Eastman Chemical Co.) may be cited.

The APAO as the component (A) is known in various forms such as, for example, homopolymers or copolymers of atactic polypropylene, atactic polybutene-1, etc., copolymers or terpolymers of propylene, ethylene, butene-1, etc., and propylene homopolymer, propylene-butene copolymer, and propylene-ethylene copolymer.

The B component of the hotmelt to be used in this invention is a tackifier resin (B). The tackifier resin (B) has a softening point exceeding 110° C. and falling preferably in the range of 110°-180° C. and more preferably in the range of 120°-160° C. The tackifier resin (B) answering this description is known in various forms such as, for example, aliphatic petroleum resin, aromatic petroleum resin, wholly hydrogenated aliphatic petroleum resin, wholly hydrogenated aromatic petroleum resin, partially hydrogenated petroleum resin, partially hydrogenated aromatic petroleum resin, α-pinene resin, terpene resin, terpene-modified phenol resin, styrene resins, rosin resin, and modified resins thereof. The adhesiveness expected of the hotmelt is acquired by selecting more than one member from the group of resins enumerated above and compounding it and the other component of the hotmelt together in proper amounts. As typical examples of the tackifier resin, rosin, hydrogenated rosin, esters of rosin, terpene, and modified terpene may be cited. The preferred amounts of APAO/tackifier resin are in the range of 100/10-100/100, preferably in the range of 100/30-100/60 in weight ratio. If the amount of the tackifier resin falls short of 10 parts by weight, the shortage will result in thinning the wettability of the pre-applied adhesives and degrading the adhesiveness thereof to a molded object. Conversely, if the amount exceeds 100 parts by weight, the excess will result in lowering the resistance to heat of the adhesives.

To cite typical examples of the commercially available product of the tackifier resin, YS resin PX1250 (softening point 125° C.) and YS resin PX1150 (softening point 115° C.) , i.e. products of modified terpene resin, YS resin TO125 (softening point 125° C.) and YS resin TO115 (softening point 110° C.), i.e. products of modified terpene resin, Clearon P125 (softening point 125° C.), Clearon 115 (softening point 115° C.), YS Polyster-U115 (softening point 115° C.), YS Polister-2130 (softening point 130° C.), YS Polyster-2115 (softening point 115° C.), YS Polyster-S145 (softening point 145° C.), YS Polyster-N125 (softening point 125° C.), Mightyace G150 (softening point 130° C.), Mightyace G125 (softening point 125° C.), and YS Polyster-TH130 (softening point 130° C.), i.e. products of hydrogenated terpene resin (all made by Yasuhara Chemical K.K.), Tamanol 900 (softening point 120°-135° C.), i.e. a product of terpene phenol resin and Tamanol 135 (softening point 130°-140° C.), i.e. a product of rosin-modified phenol resin (both made by Arakawa Kagaku K.K.), Pentalin 2541 (softening point 111-121° C.), i.e. a product of rosin ester (made by Rika Hercules K.K.), Pentalin FK125 (softening point 122-128° C.), i.e. a product of modified rosin ester (made by Rika Hercules K.K.), and Pentalin 4741 (softening point 120°-130° C.), i.e. a product of maleic acid-modified rosin ester (made y Rika Herculess K.K.) may be cited.

The C component of the hotmelt to be used in this invention is a polypropylene wax (C). The polypropylene wax (C) is a crystalline wax having a melting point exceeding 120° C. and preferably falling in the range of 120°-170° C. and more preferably in the range of 130°-160° C. If any wax other than the wax specified above is used, the produced hotmelt will have an unduly low melting point and fail to realize a fully satisfactory resistance to heat. The amount of this wax to be incorporated in the hotmelt is preferred to be such that the weight ratio of APAO/polypropylene wax may fall in the range of 100/50-100/100, and especially in the range of 100/50-100/80. If the amount of polypropylene type wax falls short of 50 parts by weight or exceeds 100 parts by weight, the deviation will result in preventing the produced hotmelt from acquiring fully satisfactory resistance to heat.

The composition of the hotmelt of this invention may incorporate therein at least one polyolefin selected from the group consisting of polyethylene, polypropylene, and ethylene-styrene block copolymers for the purpose of adjusting viscosity, speed of crystallization, and adhesive property at low temperatures. The amount of the polyolefin to be used is not more than 30 weight %, preferably not more than 10 weight %, based on the total weight of the hotmelt composition.

As the antioxidant, hindered phenol antioxidant, phosphorus type processing heat stabilizer, lactone type processing heat stabilizer, and sulfur type heat resistance stabilizer may be cited, for example.

Optionally, the composition may incorporate therein various additives such as inorganic filler, and coloring agent. It may further incorporate therein a varying agent for imparting compatibility.

These components of the composition are required to be worked with a kneader as kept heated to produce the hotmelt.

The application of the hotmelt composition obtained as described above to the polyolefin foam surface on the back surface of the outer layer material or the surface layer material may be accomplished by directly applying the hotmelt composition as with a roll coater, a die coater, or a spray to the surface by the use of an ordinary hotmelt applicator after the production of the outer layer material. Alternatively, the application maybe effected by spreading the hotmelt composition on a release paper and heat transferring the spread layer of the hotmelt composition to the foam surface. The thickness of the hotmelt composition to be applied, though variable as with the smoothness of the surface of the target for coating which is destined to form a molded object, is such that the adhesive layer consequently formed will have a thickness in the approximate range of 10-500 μm and preferably in the approximate range of 50-200 μm. If the thickness falls short of 10 μm, the shortage will result in unduly decreasing the surface of adhesion to the molded object and degrading the adhesive property of the composition. Conversely, if the thickness exceeds 500 μm, the excess will result in preventing the outer layer material, while being heated, from being softened fully satisfactorily within a prescribed span of time, no longer enabling the hotmelt to acquire wettability to the molded object, and degrading the adhesiveness of the hotmelt.

The outer layer material to be used in this invention is a sheetlike material which is either formed solely of a surface layer material made of a thermoplastic sheet of polyvinyl chloride or thermoplastic polyolefin and a fibrous material such as tricot, woven fabric, or non-woven fabric or formed by laminating by adhesion or thermal fusion the surface layer material and a polyolefin foam produced by using polypropylene, polyethylene, polybutylene and a copolymer of such olefins as a main component. Generally, the outer layer material has a thickness in the approximate range of 0.3-1.5 mm and the polyolefin type foam has a thickness in the approximate range of 1.5-3 mm. The term “molded object” as used herein means injection molded objects and sheets of varying plastic substances such as acrylonitrile-butadiene-styrene resin (ABS resin) and polypropylene and ligneous molded objects and ligneous boards obtained by solidifying by the technique of hot pressing wood chips and ligneous flour with a thermosetting resin or a polyolefin resin.

The pre-applied outer layer material for automotive interior trim which is obtained by applying the hotmelt may be cut in a prescribed size, mounted in a vacuum forming device, and molded. The vacuum forming is an operation which comprises thermally softening a pre-applied outer layer material mounted in position with hot air or the heat of infrared ray and closely joining the adhesives surface of the pre-applied outer layer material to the molded object till fast adhesion while keeping the softened pre-applied outer layer material aspirated by vacuum away from the molded object mounted on the male die of molding and furnished with minute pores. In this case, the pre-applied outer layer material is required to have been heated to a temperature in the range of 100° C.-150° C. by the time of adhesion, whereas the molded object is only required to have a temperature of not lower than 5° C. at the time of adhesion and, even during the winter, does not need to be particularly heated in a room conditioned to the neighborhood of habitability. Further, in the case of the vacuum forming insertion, a method of applying pressure from the outer layer surface by means of compressed air, a female die of molding, or a membrane is popular and brings a favorable result. Since the molded object is used in a state not heated in advance, the line which has been using solvent type adhesives and emulsion type adhesives can be used in its unmodified state. Further, since the adhesives are a hotmelt, the pre-applied outer layer material of this invention is at an advantage in obviating the necessity for a solvent and reacting very efficiently to the environment.

Now, this invention will be described more specifically below with reference to working examples and controls. This invention, however, is not restricted by these examples. The word “part” used hereinafter refers invariably to “part by weight.”

(Method of Testing)

(Mounting test, heat-resisting creep) An outer layer material immediately after adhesion to a polypropylene plate was cut in a width of 25 mm. The strip thus obtained was subjected in an atmosphere of 20° C. to 180-degree peeling at a rate of pulling of 200 mm/min. to determine strength and state of failure. The results were rated on a three-point scale, wherein:

A denotes failure from polypropylene plate (poor rating)

B denotes failure of foam in outer layer material (good rating)

C denotes cohesive failure of hotmelt (poor rating)

A similar joined sample was subjected in an atmosphere of 100° C. to a creep test under a load of 100 g in a direction of 90 degrees for 24 hours to determine length of slip and state of failure.

### EXAMPLE 1

In a heating kneader kept at 170°±10° C., 100 parts of APAO (melting viscosity about 1,500 mPa·s/190° C.) (made by Ube Kosan K.K. and sold under the trademark designation of “Ubetack UT2715), 30 parts of a tackifier resin (softening point determined by the ring and ball method of 140° C.) (made by Arakawa Kagaku K.K. and sold under the trademark designation of “Arkon P140”), and 5 parts of an antioxidant (made by Ciba Specialty Chemical K.K. and sold under the trademark designation of Irganox 1010”) were dissolved and kneaded for 2 hours. Thereafter, the resultant mixture and 50 parts of a polypropylene wax (melting point 145° C. (made by Sanyo Kasei Kagaku K.K. and sold under the trademark designation of “Viscol 660P”) were added together and kneaded for 2 hours to obtain a hotmelt (I). The hotmelt (I) was applied in a thickness of 100 μm by the use of a hot roll coater heated in advance to 170° C. to a polypropylene foam surface of an automotive interior trim (a laminate formed of a surface layer material made of a polyolefin type sheet and a foam of a thickness of 25 mm using polypopylene as a main component and expanded to 15 times the original volume; made by Okamoto K.K.) to obtain a pre-applied outer layer material for automotive interior trim. The pre-applied outer layer material mentioned above was heated till the surface temperature thereof reached 150° C. and enabled by vacuum forming to adhere to the polypropylene plate. The adhesives showed a good adhesive property to the polypropylene plate from the beginning and acquired a high resistance to heat.

### EXAMPLE 2

In the same manner as in Example 1, 100 parts of APAO (melting viscosity about 1,500 mPa·s/190° C.) (made by Ube Kosan K.K. and sold under the trademark designation of “Ubetack UT2715”), 30 parts of a tackifier resin (made by Arakawa Kagaku K.K. and sold under the trademark designation of Arkon P140), and 2 parts of an antioxidant (made by Ciba Specialty Chemical K.K. and sold under the trademark designation of “Irganox 1010”) were dissolved and kneaded for 2 hours in a heating kneader heated in advance to 170°±10° C. Thereafter, the resultant mixture and 100 parts of a polypropylene wax (made by Sanyo Kasei Kogyo K.K. and sold under the trademark designation of “Viscol 660P”) were added and kneaded together for 2 hours to obtain a hotmelt (II). This hotmelt showed a good adhesive property to the polypropylene plate from the beginning and acquired high resistance to heat.

### EXAMPLE 3

In the same manner as in Example 1, 100 parts of APAO (melting viscosity about 19,000 mPa·s/190° C.) (made by Ube Kosan K.K. and sold under the trademark designation of “Ubetack E27200”), 30 parts of a tackifier resin (made by Arakawa Kagaku K.K. and sold under the trademark designation of “Arkon P140”), and 2 parts of an antioxidant (made by Ciba Specialty Chemical K.K. and sold under the trademarked designation of “Irganox1010”) were dissolved and kneaded for 2 hours in a heating kneader heated in advance to 170°±10° C. Thereafter, the resultant mixture and 80 parts of a polypropylene wax (made by Sanyo Kasei Kogyo K.K. and sold under the trademark designation of “Viscol 660P”) were added and kneaded together for 2 hours to obtain a hotmelt (III). This hotmelt showed a good adhesive property to the polypropylene plate from the beginning and acquired high resistance to heat.

### EXAMPLE 4

In the same manner as in Example 1, 100 parts of APAO (melting viscosity about 50,000 mPa·s/190° C.) (made by Degussa AG and sold under the trademark designation of “Bestplast 750”), 30 parts of a tackifier resin (softening point determined by the ring and ball method of 140° C.) (made by Arakawa Kagaku K.K. and sold under the trademark designation of “Arkon P140”), and 2 parts of an antioxidant (made by Ciba Specialty Chemical K.K. and sold under the trademarked designation of “Irganox1010”) were dissolved and kneaded for 2 hours in a heating kneader heated in advance to 170°±10° C. Thereafter, the resultant mixture and 80 parts of a polypropylene wax (made by Sanyo Kasei Kogyo K.K. and sold under the trademark designation of “Viscol 660P”) were added and kneaded together for 2 hours to obtain a hotmelt (IV). This hotmelt showed a good adhesive property to the polypropylene plate from the beginning and acquired high resistance to heat.

### EXAMPLE 5

In the same manner as in Example 1, 100 parts of APAO (melting viscosity about 22,000 mPa·s/190°C) (made by Degussa AG and sold under the trademark designation of “Bestplast 520”), 30 parts of a tackifier resin (softening point determined by the ring and ball method of 140° C.) (made by Arakawa Kagaku K.K. and sold under the trademark designation of “Arkon P140”) , and 2 parts of an antioxidant (made by Ciba Specialty Chemical K.K. and sold under the trademarked designation of “Irganox1010”) were dissolved and kneaded for 2 hours in a heating kneader heated in advance to 170°±10C. Thereafter, the resultant mixture and 80 parts of a polypropylene wax (made by Sanyo Kasei Kogyo K.K. and sold under the trademark designation of “Viscol 660P”) were added and kneaded together for 2 hours to obtain a hotmelt (V). This hotmelt showed a good adhesive property to the polypropylene plate from the beginning and acquired high resistance to heat.

### EXAMPLE 6

In the same manner as in Example 1, 100 parts of APAO (melting viscosity about 19,000 mPa·s/190° C.) (made by Ube Kosan K.K. and sold under the trademark designation of “Ubetack E27200”), 30 parts of a tackifier resin (made by Arakawa Kaagaku K.K. and sold under the trademark designation of “Arkon P140”), and 2 parts of an antioxidant (made by Ciba Specialty Chemical K.K. and sold under the trademark designation of “Irganox 1010”) were dissolved and kneaded for 2 hours in a heating kneader heated in advance to 170°±10° C. Thereafter, the resultant mixture and 80 parts of a polypropylene wax (made by Sanyo Kasei Kogyo K.K. and sold under the trademark designation of “Viscol 660P”) were added and kneaded together for 2 hours to obtain a hotmelt (VI). This hotmelt showed a good adhesive property to the polypropylene plate from the beginning and acquired high resistance to heat.

### EXAMPLE 7

In the same manner as in Example 1, 100 parts of APAO (melting viscosity about 8,000 mPa·s/190° C.) (made by Ube Kosan K.K. and sold under the trademark designation of “Ubetack UT2780), 80 parts of a tackifier resin (made by Arakawa Kagaku K.K. and sold under the trademark designation of “Arkon P14”0), and 2 parts of an antioxidant (made by Ciba Specialty Chemical K.K. and sold under the trademarked designation of “Irganox1010”) were dissolved and kneaded for 2 hours in a heating kneader heated in advance to 170°±10° C. Thereafter, the resultant mixture and 80 parts of a polypropylene wax (made by Sanyo Kasei Kogyo K.K. and sold under the trademark designation of “Viscol 660P”) were added and kneaded together for two hours to obtain a hotmelt (VII).

This hotmelt showed a good adhesive property to the polypropylene plate from the beginning and acquired high resistance to heat.

### EXAMPLE 8

In the same manner as in Example 1, 100 parts of APAO (melting viscosity about 8,000 mPa·s/190° C.) (made by Ube Kosan K.K. and sold under the trademark designation of “Ubetack UT2780”), 100 parts of a tackifier resin (softening point determined by the ring and ball method of 140° C.) (made by Arakawa Kagaku K.K. and sold under the trademark designation of “Arkon P140”), and 2 parts of an antioxidant (made by Ciba Specialty Chemical K.K. and sold under the trademark designation of “Irganox 1010”) were dissolved and kneaded for 2 hours in a heating kneader heated in advance to 170±10° C. Thereafter, the resultant mixture and 80 parts of a polypropylene wax (made by Sanyo Kasei Kogyo K.K. and sold under the trademark designation of “Viscol 660P”) were added and kneaded together for 2 hours to obtain a hotmelt (VIII). This hotmelt showed a good adhesive property to the polypropylene plate from the beginning and acquired high resistance to heat.

Control 1

A hotmelt was obtained by following the procedure of Example 1 while changing the tackifier resin to a tackifier resin of a low softening point (softening point determined by the ring and ball method of 100° C.) (made by Arakawa Kagaku K.K. and sold under the trademarked designation of “Arkon P100”) . It was applied by way of pre-applied to a polypropylene foam surface of an outer layer material for automotive interior trim and joined to a polypropylene plate by adhesion.

The laminate consequently obtained suffered the outer layer material thereof to show a discernible sign of failure in a test for 180 degree peel and produce a slip in a test for 100° C. creep.

Control 2

A hotmelt was obtained by following the procedure of Example 1 while changing the amount of the polypropylene wax (made by Arakawa Kagaku K.K. and sold under the trademark designation of “Arkon P100”) to 20 parts. It was applied by way of pre-applied to a polypropylene foam surface of an outer layer material for automotive interior trim and joined to a polypropylene plate by adhesion.

The laminate consequently obtained suffered the outer layer material thereof to show a discernible sign of failure in a test for 180 degree peel and produce a slip in a test for 100° C. creep.

Control 3

A hotmelt was obtained by following the procedure of Example 1 while changing the amount of a polypropylene wax (made by Sanyo Kasei Kogyo K.K. and sold under the trademark designation of “Viscol 660P”) to 200 parts. It was applied by way of pre-applied to a polypropylene foam surface of an outer layer material for automotive interior trim and joined to a polypropylene plate by adhesion.

The laminate consequently obtained suffered the outer layer material thereof to reveal deficiency in adhesiveness to the polypropylene plate in a test for 180 degree peel and produce a slip in a test for 100° C. creep.

Control 4

A hotmelt was obtained by following the procedure of Example 1 while changing the amount of the tackifier resin (softening point determined by the ring and ball method of 140° C.) (made by Arakawa Kagaku K.K. and sold under the trademark designation of “Arkon P100”) to 20 parts and the amount of the polypropylene type wax (made by Sanyo Kasei Kogyo K.K. and sold under the trademark designation of “Viscol 660P”) to 120 parts. It was applied by way of pre-applied to a polypropylene foam surface of an outer layer material for automotive interior trim and joined to a polypropylene plate by adhesion.

The laminate consequently obtained suffered the outer layer material thereof to show a discernible sign of failure in a test for 180 degree peel and produce a slip in a test for 100° C. creep.

TABLE 1

| Materials for | | | | | | | | | | | | |
|---|---|---|---|---|---|---|---|---|---|---|---|---|
| compounding and | Example | | | | | | | | Control | | | |
| item of test | 1 | 2 | 3 | 4 | 5 | 6 | 7 | 8 | 1 | 2 | 3 | 4 |
| APAO 1) | 100 | 100 | | | | | | | 100 | 100 | 100 | 100 |
| APAO 2) | | | | | | 100 | 100 | 100 | | | | |
| APAO 3) | | | 100 | | | | | | | | | |
| APAO 4) | | | | 100 | | | | | | | | |
| APAO 5) | | | | | 100 | | | | | | | |
| Tackifier 6) | 30 | 30 | 30 | 30 | 30 | 10 | 80 | 100 | | 20 | 30 | 120 |
| Tackifier 7) | | | | | | | | | 30 | | | |
| Polypropylene wax | 50 | 100 | 80 | 80 | 80 | 80 | 80 | 80 | 50 | 30 | 200 | 80 |
| 8) | | | | | | | | | | | | |
| Antioxidant 9) | 5 | 2 | 2 | 2 | 2 | 2 | 2 | 2 | 2 | 2 | 2 | 2 |
| Peel 180° (N/25 mm) | 88B | 79B | 83B | 77B | 80B | 85B | 83B | 75B | 80B | 77B | 45C | 82B |
| 100° C. creep (mm) | 0 | 0 | 0 | 0 | 0 | 0 | 0 | 0 | 22C | 49C | Slip A | 10C |

A: Failure from polypropylene plate
B: Failure of outer layer material
C: Cohesive failure of hotmelt layer
1) Ube Tack UT2715
2) Ube Tack UT2780
3) Ube Tack E27200
4) Vestoplast 750
5) Vestoplast 520
6) Arkon P140
7) Arkon P100
8) Viscol 660P
9) Irganox 1010

The entire disclosure of Japanese Patent Application No.2003-060231filed on Mar. 6, 2003 including specification, claims, drawings, and summary are incorporated herein by reference in its entirety.

What is claimed is:

1. A pre-applied outer layer material for automotive interior trim, which comprises having applied in advance to the back surface of an automotive interior trim a hotmelt having (A) an amorphous poly(α-olefin) having a melting viscosity in the range of 500-100,000 mPa·s/190° C., (B) a tackifier resin having a softening point determined by the ring and ball method of not lower than 110° C., and (C) a polypropylene wax having a melting point of not lower than 120° C. as main components thereof and having a weight ratio of (A) to (C) in the range of 100/50-100/100.

2. A pre-applied outer layer material according to claim 2, wherein said outer layer material for automotive interior trim is formed solely of a surface layer material and said hotmelt is directly applied in advance to the back surface of said outer layer material.

3. A pre-applied outer layer material according to claim 2, wherein said outer layer material for automotive interior trim is formed of a surface layer material and a polyolefin foam layer joined to the back surface thereof by adhesion or thermal fusion and said hotmelt is applied to the surface of said polyolefin foam layer.

4. A pre-applied outer layer material according to claim 1, wherein the weight ratio of (A) the amorphous poly(α-olefin)/(B) the tackifier resin is in the range of 100/10-100/100.

5. A pre-applied outer layer material according to claim 1, wherein the thickness of said hotmelt applied to the outer layer material is in the range of 10-500 μm.

6. A pre-applied outer layer material according to claim 4, wherein said hotmelt further contains not more than 0 weight % of a polyolefin based on the weight of said hotmelt.

7. A pre-applied outer layer material according to claim 3, wherein said outer layer material is formed solely of a thermoplastic sheet or fibrous material or formed by laminating a polyolefin foam thereon.

8. A pre-applied outer layer material for automotive interior trim, which comprises having applied in advance to the back surface of an automotive interior trim a hotmelt having (A) an amorphous poly(α-olefin) having a melting viscosity in the range of 500-100,000 mPa·s/190° C., (B) a tackifier resin having a softening point determined by the ring and ball method of not lower than 110° C., and (C) a polypropylene wax having a melting point of not lower than 120° C. as main components, having a weight ratio of (A) to (C) in the range of 100/50-100/100, and having a weight ratio of (A) the amorphous poly(α-olefin)/(B) the tackifier resin in the range of 100/10-100/100.

9. A pre-applied outer layer material according to claim 7, wherein the weight ratio of (A)/(C) is in the range of 100/30-100/60 and the weight ratio of (A)/(B) is in the range of 100/50-100/80.

10. A pre-applied outer layer material according to claim 8, wherein said automotive interior trim is formed solely of a surface layer material and said hotmelt is directly applied in advance to the back surface of said surface layer material.

11. A pre-applied outer layer material according to claim 8, wherein said automotive interior trim is formed of a surface layer material and a polyolefin foam layer joined by adhesion to the back surface thereof and said hotmelt is applied to the surface of said polyolefin foam layer.

12. A method for the production of an automotive interior trim, comprising the steps of applying a pre-applied outer layer material set forth in claim 1 to a molded object and subjecting them to vacuum forming adhesion without heating the molded object.
